(19) United States
(12) Patent Application Publication
(10) Pub. No.: US 2008/0065464 A1
(43) Pub. Date: Mar. 13, 2008

(54) Predicting response rate

(76) Inventors: Mark Klein, New Castle, NH (US); Brian Jenkins, Portsmouth, NH (US); Loren D. Meeker, Lee, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/517,180

(22) Filed: Sep. 7, 2006

(51) Int. Cl. G06F 17/30

(52) U.S. Cl. 705/10

(57) ABSTRACT

A process for predicting response rates, such as to a marketing campaign. In general, the process involves collecting data concerning past transactions; using past transaction data to identify bins, or groups, of customers exhibiting similar purchase behavior in the past; summarizing (statistically) the average purchase behavior for each bin of customers and compiling the bin statistics for use in campaign planning; assign customers to appropriate bins (previously identified and statistically described) based on their past and most recent purchasing records; using the previously calculated bin statistics to estimate the likely number of purchasers and expected average revenue for each bin of customers; calculating a predicted total revenue by summing expected average revenues for each bin; calculating a predicted response rate; executing the marketing campaign; collecting data for new transactions; comparing the predicted and actual revenue and response rates; and using these comparisons to adjust and improve the methods of prediction for use in future campaigns.

### RELATED APPLICATION(S)

This application is related to U.S. patent applications Attorney Docket No. 4081.1002-000 entitled “Factorial Design Expert System ” filed on Sep. 7, 2006 and Attorney Docket No. 4081.1000-000 entitled “Online Direct Marketing System” filed on Sep. 7, 2006. The entire teachings of all of the above application(s) are incorporated herein by reference.

### BACKGROUND OF THE INVENTION

The present invention is generally related to predictive analytics and behavioral targeting for marketing services and more particularly to dynamically predicting response rates and expected revenue for an upcoming marketing campaign.

Marketing campaigns can be difficult to deploy and expensive to develop. There is an ongoing need to predict the expected revenue and response rate to a marketing campaign before the campaign is launched, so that variables can be adjusted for maximum returns. When this prediction needs to be done quickly, for example inside an interactive online system, or when there are many potential customers, it is impractical to estimate and add up the potential dollars from each individual customer.

### SUMMARY OF THE INVENTION

Marketers would have a competitive advantage if they could predict, in advance, and by using automated methods, how well a campaign would be received; what the response rate of the targeted customers would be; and how much revenue can be expected from the campaign. If the predictions indicate possibly unsatisfactory results, the campaign parameters could then be modified to yield better returns.

This invention describes a prediction process that delivers fast and accurate estimates. In general, the process involves:

collecting data concerning past transactions;

using past transaction data to identify bins, or groups, of customers exhibiting similar purchase behavior in the past;

summarizing (statistically) the average purchase behavior for each bin of customers and compiling the bin statistics for use in campaign planning;

at the campaign planning stage, assign customers to appropriate bins (previously identified and statistically described) based on their past and most recent purchasing records;

using the previously calculated bin statistics to estimate the likely number of purchasers and expected average revenue for each bin of customers;

calculating a predicted total revenue by summing expected average revenues for each bin;

calculating a predicted response rate;

executing the marketing campaign;

collecting data for new transactions;

comparing the predicted and actual revenue and response rates; and

using these comparisons to adjust and improve the methods of prediction for use in future campaigns.

In a preferred embodiment, customers can be grouped into approximately 25 to 100 “bins”, where all the customers in a bin are fairly homogeneous with respect to bin-defining metrics such as purchase propensity, number of prior orders, and recency.

The probability of customers in a given bin making a purchase is typically calculated from bin-based statistics. From this, the total number of purchases by all customers in the bin over a defined interval is then calculated by the supplied formula.

The expected revenue from these purchases is obtained by multiplying the number of purchases by the average revenue per purchase. This is summed over all the bins to obtain the total revenue.

The expected response rate can be estimated by dividing the expected number of buyers in all bins by the total number of customers in all bins.

Confidence intervals for the important parameters are provided to assess the reliability of the estimated responses.

By comparing the predicted to the actual response rate, techniques are identified to adjust the bin-based statistics model, such as by using linear and/or non-linear optimization techniques, to improve future predictions. Thus, the system learns over time to be more accurate. Predictions can be compared on a real-time basis with actual results as new data becomes available.

A typical use for this invention would be as a component in an Online Direct Marketing System, as described in the co-pending patent application referenced above.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a high level diagram illustrating the components of a data processing system in which an automated response rate prediction process may be implemented.

FIG. 2 is a flow diagram of the steps performed in response rate prediction.

### DETAILED DESCRIPTION OF THE INVENTION

A description of preferred embodiments of the invention follows.

A. Overview of System Architecture

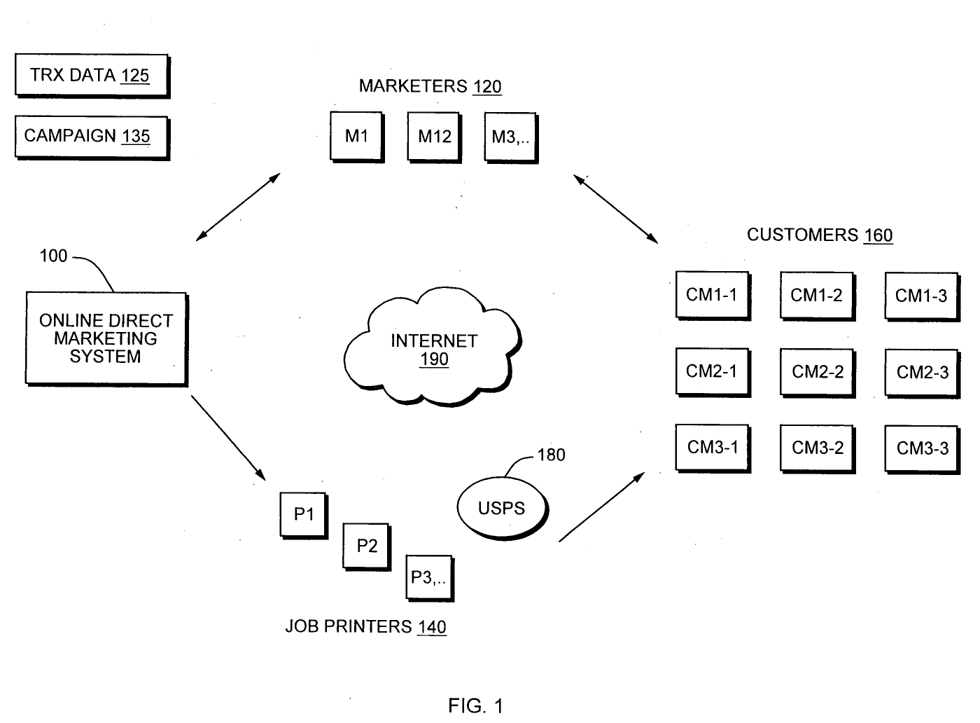

FIG. 1 is a high level diagram of a data processing environment in which a campaign response rate prediction process may be carried out. Several entities interact, directly or indirectly, with an On-Line Direct Marketing System (ODMS) 100. These include Marketers 120 (individually referenced as M1, M2, M3, . . . in the figure); Job Printers 140 (P1, P2, . . . ); and Customers 160 (CM-1, CM1-2, . . . ). Marketers 120 use the ODMS 100 to create and execute the campaigns. Customers 160 are the customers of the products or services offered by Marketers 120 (directly or indirectly). Customers 160 are individually denoted by CMx-y, where x references Marketer x, and y is the customer number. Job Printers 140 execute portions of the campaign, such as to produce and mail promotional materials Customers 160, such as by using the U.S. Postal Service 180 (USPS).

In general, an automated direct marketing campaign process according to the invention involves the Marketers 120 uploading transaction data (TRX) concerning past transactions with Customers 160 to the OMDS 100. The Marketers use the ODMS 100 to interactively design and test campaigns, based on analytics derived from the transaction data within the ODMS 100. A campaign is then selected within the ODMS 100, which then can be downloaded to the marketer's own system or automatically executed, such as by sending instructions to Job Printers 140. Most but not all communications between these entities happen over the Internet 190, shown as a cloud in the center of FIG. 1. While only a few instances of each entity are shown in FIG. 1, it should be understood that the ODMS 100 can accommodate anywhere from a few to many, many instances of each type of marketers 120, printers 140 and customers 160. As described in more detail below, elements of the system are implemented in database and software application servers, and thus the system is easily scaled to accommodate demand.

The internal architecture and data flows of one embodiment of the ODMS 100 is not critical to the present invention. However, in one embodiment, this includes front end data processing elements, such as web servers (which may include HTTP server, SMTP server and/or FTP server), and database (DB) servers. Back end data processing elements typically include work queues, controllers, storage, and analysis severs. In general, Marketers 120 upload transaction data files to storage servers, typically embodied as a Storage Area Network (SAN). Upon instructions from a controller, one of several Analysis Servers access the uploaded files to analyze, segment (place into “bins”, and score the Customers 160 based on their transaction history (e.g., performing Analysis as described below). More detail of a specific data flow is contained in the co-pending patent application that is reference above. Analysis results are then added to storage location and/or web-facing database servers.

B. Prediction of Campaign Response Rate

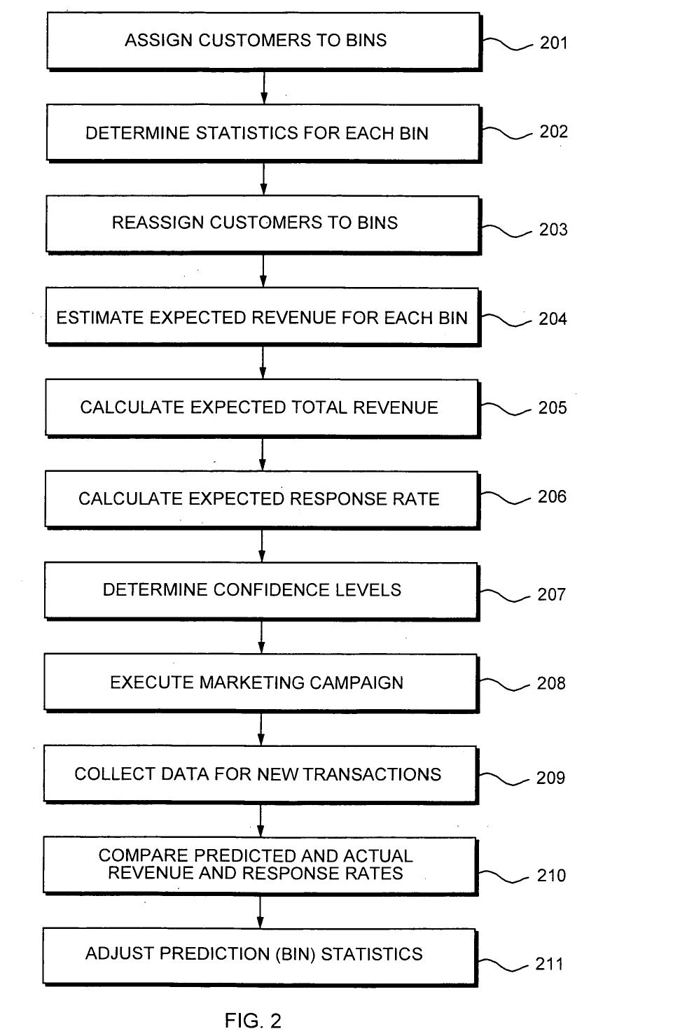

A preferred embodiment for a process to predict campaign response rate is shown in detail in FIG. 2. Several assumptions are made in connection with this process:
1. There is detailed past transaction data (history) for Customers 160.
2. The Customers 160 have been scored by any one of several methods that are known in the art, for example using regression, neural nets, genetic algorithms, RFM, or finite state machines.
3. After scoring, the Customers 160 are grouped into segments with other customers having similar scores.
4. Other customer metrics are available, including but not limited to
   a. Intent to purchase in the near future
   b. Number of prior purchases
   c. A customer's recency (time since last purchase) relative to their previously established temporal purchasing behavior.

### Method:

Step 201. Identify bins (groups) of customers with similar past purchasing behavior. Periodically upon receipt of new transaction data, Customers 160 are grouped in bins based on their scores for the bin-defining metrics using the new data. The groupings are based on all transactions up to the beginning of the most recent past period (week, month, quarter as appropriate). For example, a typical bin might be described by:
Purchase propensity in the following period (e.g., between 60 and 70 percent),
Number of prior orders (e.g., between 5 and 10 prior orders),
Relative recency (e.g., between 2 and 3).

So a customer with purchase propensity 65%, 7 prior orders, and relative recency of 2.6 would be assigned to one sample bin while a customer with purchase propensity of 75% would be assigned to a different sample bin regardless of their values on the other metrics. The number of bins is variable but is generally in a range from about 25-100 bins.

Step 202. Determine statistics for each bin. The purchase behavior to be expected of each bin of customers is summarized by a number of pertinent bin-based statistics. These statistics may include, but are not limited to
p, the probability of making at least one purchase in the interval;
n, the average number of purchases per purchasing customer (buyer);
r, the average revenue per purchase by bin buyers over the interval.

Step 203. Assign potential campaign target customers to bins. To develop campaign forecasts for future periods, the customers targeted for the campaign are assigned to the previously defined bins based on their current (most recent period) bin metrics (which may be different from their previous bin grouping at the original bin identification analysis of Step 201 because of the passage of time). For example, if a given bin j contains n(j) customers and the estimated probability of a customer in that bin making at least one purchase in the campaign interval is p(j), based on the previous bin statistical analysis outlined above, then all customers in the bin are assumed to have a purchase probability of p(j) and the number of buyers, B(j), has the binomial distribution with parameters n(j) and p(j) with expected value and variance of b(j)=n(j)·p(j) and σ_{B(j)}²=n(j)·p(j)·(1−p(j)), respectively.

Step 204. Estimate expected revenue for each bin. If m(j) is the average number of purchases per buyer in bin j and r(j) is the average revenue per purchase in bin j, then the expected number of purchases and expected revenue from bin j are m(j)·b(j) and r(j)·m(j)·b(j), respectively.

Step 205. Calculate expected total revenue. The expected total revenue, T, is estimated by the sum of the expected revenue from each bin

$$T = {\sum }_{j} r ( j ) \cdot m ( j ) \cdot b ( j ) .$$

Step 206. Calculate expected response rate. The expected response rate is estimated by the sum of expected number of buyers in all bins divided by the total number of customers in all bins

$$\frac{{\sum }_{j} b ( j )}{{\sum }_{j} n ( j )} .$$

Step 207. Determine confidence levels. Predictions without some measure of the range of possible error are not very useful. This invention uses confidence intervals to estimate that range for the expected number of buyers, expected number of purchases, and expected revenue. The confidence intervals are based upon the bin variances σ_{B(j)}², (above), σ_{M(j)}², the estimated variance of, M(j), the purchases per buyer, and σ_{R(j)}², the estimated variance of R(j), the revenue per purchase of each bin, using techniques well known to persons reasonably skilled in statistics. The number of bin customers is chosen sufficiently large that confidence intervals based on Gaussian statistics are justified for all distributions. In general, 95% confidence intervals are estimated which have the property that, in the absence of external market factors, approximately 95 of 100 such intervals will contain the true mean value of the estimated quantity (number of buyers, number or purchases, or total revenue).

Step 208. The marketing campaign is executed. In general, Marketers can use the ODMS 100 to interactively design and test campaigns. A campaign is then selected within the ODMS 100, which then can be downloaded to the marketer's own system or automatically executed, such as by sending instructions to Job Printers 140. Most but not all communications between these entities happen over the Internet 190, shown as a cloud in the center of FIG. 1. Job Printers 140 then produce and mail promotional materials to Customers 160, such as by using the U.S. Postal Service 180 (USPS). Other types of campaigns, email, etc. can also be used.

Step 209. Collecting data for new transactions. This step measures the actual response to the campaign. In general, this involves the Marketers 120 uploading transaction data (TRX) concerning new transactions with Customers 160 to the OMDS 100.

Step 210. Compare predictions to actual. In this step, the actual revenue and response rates from the campaign are compared to the predicted and actual revenue and response rates.

Step 211. Adapt statistical procedures to current market conditions. The bin prediction process described above is based on the statistical assumption that the purchasing behavior of each bin of customers is constant from one statistical analysis period (Step 202) to the next. This is an unlikely situation as market trends of varying duration are common. Therefore, in a final step, forecast procedures may be altered, based on comparison of the predicted to actual results, to account for improving or declining market conditions. For example, a market trend may be indicated when predictions in one or more of the variates show a consistent bias (consistently either above or below the estimated confidence interval for the variate) then the system uses standard methods of optimization (as would be known by persons reasonably skilled in this field) to minimize the error between the predicted and actual results by, for example, calculating a multiplier (or multipliers) reflecting the identified trend that will be applied to the next set of bin predictions. For example, if the predictions are consistently too conservative (indicating an increase in market activity), the multiplier will be >1 and the next set of predictions will be raised appropriately. In the opposite case, if the predictions are too optimistic, the multiplier will be <1 and the estimates will be reduced accordingly.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for dynamically predicting total revenue from future marketing campaigns comprising:
a. selecting past transaction data sets including at least an identification and past transaction for a plurality of customers;
b. identifying scoring bins containing customers of similar characteristics based on a customer scoring methodology;
c. calculating purchase statistics characterizing customers in each of the scoring bins;;
d. assigning customers to appropriate bins based on the pre-campaign behavior; and
e. using precalculated bin statistics to predict expected total revenue from each bin.

2. The method of claim 1, wherein the input transaction data sets comprise one or more of:
a. customer lists;
b. transactions made by each customer;
c. product lists of all products and services sold; and
d. promotions data describing previous campaigns.

3. The method of claim 1, wherein the scoring methodology comprise one or more of:
a. RFM;
b. Regression;
c. Neural nets;
d. Genetic algorithms; and
e. Finite State Machines.

4. A method for dynamically predicting total revenue from a future marketing campaign, comprising
collecting data for past transactions, the data including a customer identification and transaction information for a plurality of transactions;
identifying several bins, or groups, of customers having similar buying characteristics based on their past purchase behavior;
characterizing the buying behavior of each bin of customers using statistical methodology,
assigning potential campaign target customers to previously identified bins based on the customers' current purchase records;
estimating an expected revenue for customers in each bin using previously calculated bin statistics;
calculating a predicted total revenue by summing the expected revenue for each bin;
executing a campaign;
collecting actual revenue from the campaign;
comparing the predicted and actual revenue; and
adapting the prediction methodology when indicated by such comparisons.
